(19) United States
(12) Patent Application Publication
(10) Pub. No.: US 2026/0010690 A1
(43) Pub. Date: Jan. 8, 2026

(54) METHODS AND SYSTEMS FOR INTELLIGENT MONITORING OF EQUIPMENT DAMAGE BASED ON MECHANISM AND OPERATING CONDITION BIG DATA

(71) Applicants: HEFEI GENERAL MACHINERY RESEARCH INSTITUTE CO., LTD., Hefei (CN); HEFEI GENERAL MACHINERY RESEARCH INSTITUTE SPECIAL EQUIPMENT INSPECTION STATION CO., LTD., Hefei (CN); NATIONAL MACHINERY SPECIAL EQUIPMENT INSPECTION CO., LTD., Hefei (CN)

(72) Inventors: Jianxin ZHU, Hefei (CN); Yueyao XU, Hefei (CN); Zhenyu GAO, Hefei (CN); Song QIAO, Hefei (CN); Jiushao HU, Hefei (CN); Wei CHEN, Hefei (CN); Sixiang CHENG, Hefei (CN); Zhuoting FANG, Hefei (CN); Wenbin YUAN, Hefei (CN); Xiangrong FANG, Hefei (CN); Haizhou KANG, Hefei (CN)

(73) Assignees: HEFEI GENERAL MACHINERY RESEARCH INSTITUTE CO., LTD., Hefei (CN); HEFEI GENERAL MACHINERY RESEARCH INSTITUTE SPECIAL EQUIPMENT INSPECTION STATION CO., LTD., Hefei (CN); NATIONAL MACHINERY SPECIAL EQUIPMENT INSPECTION CO., LTD., Hefei (CN)

(21) Appl. No.: 19/324,097

(22) Filed: Sep. 9, 2025

Related U.S. Application Data
(63) Continuation of application No. PCT/CN2025/081545, filed on Mar. 10, 2025.

(30) Foreign Application Priority Data
Mar. 19, 2024 (CN) 202410310116.9

(51) Int. Cl. G06F 30/27; G06F 18/15; G06F 18/20; G06F 18/214; G06F 40/242; G06F 40/289; G06F 119/02; G06N 20/10

(52) U.S. Cl. CPC G06F 30/27; G06F 18/15; G06F 18/2148; G06F 18/285; G06F 40/242; G06F 40/289; G06N 20/10; G06F 2119/02

(57) ABSTRACT

A method and system for intelligent monitoring of equipment damage based on mechanism and operating condition big data are provided. The method includes: setting damage modes of pressure equipment, building mechanism model samples for each damage mode based on a technical standard and engineering cases, building operating condition big data samples for the each damage mode based on field data; building a mechanism model and an operating condition model based on the mechanism model samples and the operating condition big data samples respectively; inputting real-time text data and real-time operating condition data into the mechanism model and the operating condition model respectively, calculating a first possibility that the real-time text data belongs to each damage mode, and a second possibility that the real-time operating condition data belongs to the each damage mode, generating an equipment damage monitoring result based on the first possibility and the second possibility.

### CROSS-REFERENCE TO RELATED APPLICATIONS

This application is a Continuation of International Application No. PCT/CN2025/081545, filed on Mar. 10, 2025, which claims priority of Chinese Application No. 202410310116.9, filed on Mar. 19, 2024, the entire contents of each of which are hereby incorporated by reference.

### TECHNICAL FIELD

The present disclosure relates to a technology field of industrial equipment detection, and in particular to a method and system for intelligent monitoring of equipment damage based on mechanism and operating condition big data.

### BACKGROUND

In process industries such as petrochemicals, pressure equipment operates under complex processes and fluctuating operating conditions, which increases the risk of damage and failure of the pressure equipment. Based on application scenarios (e.g., a type of device/equipment, equipment materials, process media involved, etc.) and operating parameters (e.g., temperature, pressure, pH value, corrosive medium content, etc.) of the pressure equipment, monitoring and early warning of possible damage to the pressure equipment play an important role in ensuring a safe and reliable operation of the equipment.

Currently, passive manners are usually used for damage prevention and control of the pressure equipment. For example, regular or irregular measurements are taken at positions where thinning has occurred, and crack monitoring is performed on cracked parts, which are all detected after damage occurs, and cannot automatically prevent and control damage to the operating equipment when the damage occurs. On the other hand, the analysis of damage modes in the pressure equipment during service relies heavily on specialized databases and extensive expert experience, making it impossible to carry out large-scale automatic damage analysis, which seriously affects the safe and long-term operation of the pressure equipment. Therefore, an urgent solution is needed.

### SUMMARY

One or more embodiments of the present disclosure provide a method for intelligent monitoring of equipment damage based on mechanism and operating condition big data, wherein the method is used for monitoring damage modes of pressure equipment, the method comprises: setting a plurality of damage modes of the pressure equipment, building mechanism model samples for each damage mode based on a technical standard and engineering cases, and building operating condition big data samples for the each damage mode based on field data; before building the operating condition big data samples, building a custom dictionary and a stop words list related to the plurality of damage modes of the pressure equipment; building the mechanism model samples and building the operating condition big data samples includes: obtaining the mechanism model samples describing the each damage mode from the technical standard and the engineering cases, and obtaining operating condition data samples describing the each damage mode from the field data; cleaning, segmenting, filtering stop words, and deduplicating first text samples obtained from the technical standard according to the custom dictionary and the stop words list to obtain a technical standard keyword library; simulating a mechanism model recognition manner and expert experience, obtaining self-generated technical standard keyword samples according to the technical standard keyword library, and jointly building the mechanism model samples with second text samples obtained from the engineering cases; and retaining operating condition parameters of preset types in the operating condition data samples and deleting operating condition parameters of other types to obtain the operating condition big data samples; using the mechanism model samples and the operating condition big data samples as a dataset for model training, respectively to build a mechanism model and an operating condition model; and inputting real-time text data to be predicted and real-time operating condition data into the mechanism model and the operating condition model respectively, calculating a first possibility that the real-time text data belongs to each of the plurality of damage modes, and a second possibility that the real-time operating condition data belongs to the each of the plurality of damage modes, generating an equipment damage monitoring result based on the first possibility and the second possibility; a first possibility set P(1) that the real-time text data belongs to the each of the plurality of damage modes is expressed as: P(1)={P₁₁, P₁₂, P₁₃, . . . , P₁ₙ}; a second possibility set P(2) that the real-time operating condition data belongs to the each of the plurality of damage modes is expressed as: P(1)={P₂₁, P₂₂, P₂₃, . . . , Pₙ₂}, where P₁ₙ denotes a first possibility that the real-time text data belongs to a n-th damage mode; and P₂₂ denotes a second possibility that the real-time operating condition data belongs to a n-th damage mode; multiplying the first possibility and the second possibility that the real-time text data and the real-time operating condition data belong to a same damage mode to obtain a comprehensive possibility set {P₁₁, P₂, P₃, . . . , Pₙ} that the pressure equipment belongs to the each damage mode; wherein P₁=P₁₁×P₂₁, P₂=P₁₂×P₂₂, P₃=P₁₃×P₂₃, . . . , Pₙ=P₁ₙ×P₂ₙ; wherein, sorting possibilities in the first possibility set P(1), possibilities in the second possibility set P(2), and possibilities in the comprehensive possibility set respectively from large to small, and taking top-ranked damage modes and possibilities of the top-ranked damage modes as the equipment damage monitoring result.

One or more embodiments of the present disclosure provide a system for intelligent monitoring of equipment damage based on mechanism and operating condition big data, the system comprising: a sample building module, a model building module, and a calculation module. The sample building module is configured to set the plurality of damage modes of the pressure equipment, build the mechanism model samples for the each damage mode based on the technical standard and the engineering cases, and build the operating condition big data samples for the each damage mode based on the field data. The model building module is configured to use the mechanism model samples and the operating condition big data samples as the dataset for model training, respectively to build the mechanism model and the operating condition model. The calculation module is configured to input the real-time text data to be predicted and the real-time operating condition data into the mechanism model and the operating condition model respectively, calculate the first possibility that the real-time text data belongs to the each of the plurality of damage modes, and the second possibility that the real-time operating condition data belongs to the each of the plurality of damage modes, and generate the equipment damage monitoring result based on the first possibility and the second possibility.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is an exemplary flowchart illustrating a method for intelligent monitoring of equipment damage based on mechanism and operating condition big data according to some embodiments of the present disclosure;

FIG. 2 is an exemplary framework diagram illustrating a system for intelligent monitoring of equipment damage based on mechanism and operating condition big data according to some embodiments of the present disclosure;

FIG. 3 is a display diagram illustrating an input visualization interface of a system for intelligent monitoring of equipment damage according to some embodiments of the present disclosure;

FIG. 4 is a display diagram illustrating an operation and result interface of a system for intelligent monitoring of equipment damage according to some embodiments of the present disclosure;

FIG. 5 is a logic diagram illustrating a traditional passive risk prevention and control manner for pressure equipment; and

FIG. 6 is a logic diagram illustrating an active risk prevention and control manner for pressure equipment according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It will be understood that the terms “system”, “engine”, “unit”, “module”, and/or “block” used herein are one method to distinguish different components, elements, parts, sections, or assemblies of different levels in ascending order. However, the terms may be displaced by other expressions if they may achieve the same purpose.

As used herein, the singular forms “a”, “an”, and “the” may be intended to include the plural forms as well, unless the context clearly indicates otherwise. It will be further understood that the terms “include” and/or “comprise”, when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

The technical solutions in the embodiments of the present disclosure will be clearly and completely described below in conjunction with the drawings in the embodiments of the present disclosure. Obviously, the drawings described below are only some examples or embodiments of the present disclosure. Based on the embodiments in the present invention, all other embodiments obtained by those skilled in the art without creative work shall fall within the scope of the exemplary embodiments of this disclosure.

### Example 1

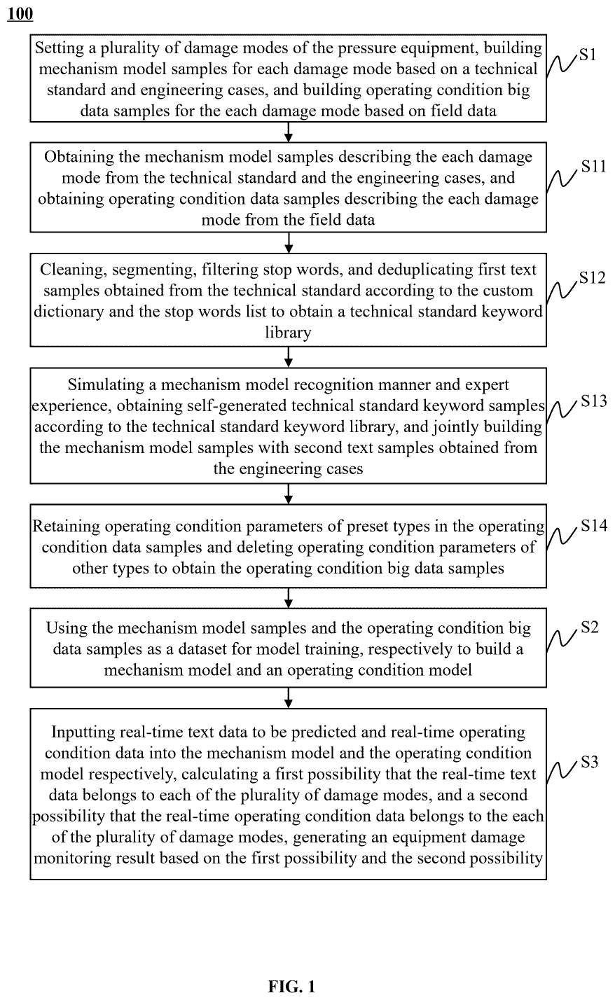

FIG. 1 is an exemplary flowchart illustrating a method for intelligent monitoring of equipment damage based on mechanism and operating condition big data according to some embodiments of the present disclosure. As shown in FIG. 1, a process 100 includes steps S1 to S3. In some embodiments, the process 100 is executed by a processor.

In some embodiments, a system for intelligent monitoring of equipment damage based on mechanism and operating condition big data may further include the processor. The processor may include a central processing unit (CPU), an application-specific integrated circuit (ASIC), an application-specific instruction set processor (ASIP), a graphics processing unit (GPU), a physics processing unit (PPU), a digital signal processor (DSP), a controller, a microcontroller unit, a reduced instruction set computer (RISC), a microcontroller, etc., or any combination thereof.

Step S1, setting a plurality of damage modes of pressure equipment, building mechanism model samples for each damage mode based on a technical standard and engineering cases, and building operating condition big data samples for the each damage mode based on field data.

The pressure equipment refers to equipment used for storing, processing, and transporting various media. For example, the pressure equipment may include a heat exchanger, a reactor, a tower, a storage tank, etc. The media may include water, steam, acid, alkali, hydrogen sulfide, carbon dioxide, etc.

The damage mode refers to a type of damage that may occur to the pressure equipment during operation.

For example, the damage mode may include Amine corrosion, high-temperature hydrogen corrosion, Naphthenic acid corrosion, etc.

In some embodiments, the each damage mode may be classified into a corresponding damage mode type. For example, the damage mode type may include corrosion thinning, environmental cracking, mechanical damage, material deterioration, or the like. The damage mode type of corrosion thinning may include amine corrosion, naphthenic acid corrosion, etc. The damage mode type of environmental cracking may include Wet hydrogen sulfide damage, etc.

In some embodiments, the damage mode may be preset by those skilled in the art based on experience.

The technical standard refers to a standard and specification used to guide and regulate the identification, monitoring, and prevention of the damage modes of the pressure equipment.

In some embodiments, the technical standard may adopt the GB/T30579 technical standard. The GB/T30579 technical standard may include information such as a damage mechanism, a damage morphology, a main influencing factor, a device or equipment prone to damage, and a main preventive measure of a damage mode. In some embodiments, the technical standard may also include a newly formulated standard for identifying the damage modes of the pressure equipment.

For example, under the damage mode of high-temperature hydrogen corrosion, in the GB/T30579 technical standard, the damage mechanism of high-temperature hydrogen corrosion may include: hydrogen molecule penetrate metals or alloys. The hydrogen atoms may react with carbides (such as iron carbide Fe₃C) and carbon in carbon steel to form methane gas (decarburization). The damage morphology may include decarburization, bubbling, cracking, degradation of mechanical properties, etc. The main influencing factors may include temperature, hydrogen partial pressure, material of the pressure equipment, operating time of the pressure equipment, etc. The device or equipment prone to damage may include ammonia synthesis units, a plurality of hydrogenation units such as reforming hydrogenation units, pressure swing adsorption hydrogen production units, and deoxygenation units, shift reactors in methanol units, boiler tubes in ultra-high pressure steam generation units, etc. The main preventive measures may include: adding elements such as chromium and molybdenum to enhance the stability of carbides and reduce methane generation, thereby improving the hydrogen corrosion resistance of steel; selecting materials with reference to the Nelson curve with an additional safety margin of 14° C. to 28° C.; and using catalysts that may lower the reaction temperature to mitigate the effects of temperature, etc.

In some embodiments, the technical standard may be directly obtained by a technician based on an industry public information.

The engineering cases refer to practical application cases related to the plurality of damage modes of the pressure equipment. In some embodiments, the engineering cases include information such as material names, media, and names of parts where damages occurred.

For example, under the damage mode of high-temperature hydrogen corrosion, in practical application cases related to high-temperature hydrogen corrosion, the material name of the pressure equipment may be carbon steel. The media carried by the pressure equipment may be hydrogen, hydrogenated oil, etc. The names of parts where damages occurred in the engineering cases may be a reactor, a heat exchanger, a methanation reactor, etc.

In some embodiments, the engineering cases may be preset by a technician based on historical data.

In some embodiments of the present disclosure, the adoption of the GB/T30579 technical standard or other newly formulated standards for identifying the damage modes of the pressure equipment is conducive to improving the precision, practicability, and efficiency of monitoring, as well as reducing costs and improving safety.

The mechanism model samples refer to text samples used for training a mechanism model. More descriptions regarding the mechanism model may be found in the related descriptions below.

In some embodiments, the processor may obtain first text samples used to describe the each damage mode from the technical standard; obtain a technical standard keyword library by processing the first text samples; and then build the mechanism model samples based on self-generated technical standard keyword samples obtained from the technical standard keyword library and second text samples obtained from the engineering cases. More descriptions regarding the building of the mechanism model samples may be found in the related descriptions below.

The field data refers to original operating status information of each pressure equipment. For example, the field data may include pressure, temperature, pH value, H₂S content, H₂O content, CO₂ content, sulfide content, NH₃ content, chloride ion content, electrochemical corrosion rate, wall thickness measurement data, etc.

In some embodiments, the processor may obtain the field data via a sensor. The sensor may include a pressure sensor, a temperature sensor, a pH value sensor, a corrosion rate probe, a gas composition sensor, a vibration sensor, or the like.

For example, the processor may obtain the pressure carried by the pressure equipment through the pressure sensor, obtain the content of various substances in the gas within the pressure equipment through the gas composition sensor, obtain the rate at which the pressure equipment is thinned by corrosion through the corrosion rate sensor, or the like.

The operating condition big data samples refer to operating condition data samples after screening. More descriptions regarding the operating condition data samples may be found in the related descriptions below.

In some embodiments, the operating condition big data samples may be used for training of an operating condition model, anomaly statistics, and subsequent simulation sample generation. More descriptions regarding the operating condition model may be found in the related descriptions below.

In some embodiments, the processor may obtain the operating condition data samples describing the each damage mode from the field data, retain operating condition parameters of preset types in the operating condition data samples and delete operating condition parameters of other types to obtain the operating condition big data samples. More descriptions regarding the building of the operating condition big data samples may be found in the related descriptions below.

In some embodiments, the processor may determine an abnormal operating condition range by statistically analyzing operating condition parameters in the operating condition data samples, and randomly generate the operating condition big data samples according to the abnormal operating condition range.

For example, the processor may perform statistical analysis on each operating condition parameter in the operating condition data samples, determine a normal distribution interval using indicators such as mean, variance, skewness, and kurtosis, and combine engineering experience to determine a normal operating condition range. The processor defines the interval beyond the normal operating condition range as the abnormal operating condition range. According to the abnormal operating condition range, the processor performs random sampling or interval disturbance generation on the abnormal operating condition range of each operating condition parameter. The processor may set sampling density and disturbance amplitude within the abnormal operating condition range, randomly select a starting point within the abnormal operating condition range, determine the positions of a plurality of subsequent sample points based on the sampling density, and increase the randomness of the samples based on the disturbance amplitude, so as to generate the operating condition big data samples covering different parameter combination scenarios for subsequent model training or verification.

In some embodiments of the present disclosure, randomly generating the operating condition big data samples according to the abnormal operating condition range is conducive to improving the robustness of the operating condition model, simulating possible abnormal situations in actual operating conditions, helping to improve the prediction precision of the operating condition model for the damage modes, and more truly simulating various operating conditions that the equipment may encounter during actual operation.

In some embodiments, the processing may also determine the mechanism model samples and operating condition big data samples based on the following steps S11 to S14.

Step S11, obtaining the mechanism model samples describing the each damage mode from the technical standard and the engineering cases, and obtaining the operating condition data samples describing the each damage mode from the field data.

The operating condition data samples refer to a large-scale, continuous, time-series operating condition parameter dataset continuously collected by a plurality of sensors configured on-site of the pressure equipment during equipment operation. The operating condition parameter dataset includes historical records of operating condition parameters and changes over time for a plurality of pressure equipment under different operating stages and different process conditions.

In some embodiments, the operating condition data samples may be presented in the form of a table. Merely by way of example, in the operating condition data samples, column headers of the table may be types of operating condition parameters (e.g., pressure, pH value, temperature, etc.), and row headers may be specific damage modes (e.g., Wet hydrogen sulfide damage, Hydrochloric acid corrosion, etc.). Each cell may be a specific operating condition parameter corresponding to the type of operating condition parameter under a specific damage mode. The operating condition parameters refer to a plurality of parameters related to an operating status of the pressure equipment. The operating condition parameters may be presented as numerical values. In some embodiments, the processor may determine the operating condition parameters corresponding to the each damage mode and type of operating condition parameter based on the field data.

In some embodiments, the processor may obtain the operating condition data samples for describing the each damage mode from the field data. For example, the processor may obtain the field data via a sensor, classify the field data based on the type of operating condition parameters, determine the type of operating condition parameter and the damage mode corresponding to each piece of field data based on an actual damage mode of the pressure equipment, and then fill all field data into a table to build the operating condition data samples.

Step S12, cleaning, segmenting, filtering stop words, and deduplicating the first text samples obtained from the technical standard according to a custom dictionary and a stop words list to obtain a technical standard keyword library.

The custom dictionary refers to a database integrating custom words. The custom words refer to words related to the plurality of damage modes. For example, custom words may include catalyze, crack, atmospheric distillation, separator tank, heavy diesel, austenitic stainless steel, etc.

In some embodiments, the custom dictionary may be preset by a technician based on experience.

The stop words list refers to a database integrating stop words. The stop words refer to words with little relevance to the damage modes. For example, the stop words may include “generally”, “together”, “also”, “whether”, “depend on”, “occur”, etc.

In some embodiments, the stop words list may be preset by a technician based on experience.

The text samples refer to specific text content. In some embodiments, the text samples may include the first text samples and the second text samples. The first text samples refer to text samples obtained from the technical standard. The second text samples refer to text samples obtained from the engineering cases. For example, the first text samples in the technical standard may be words such as catalyze, crack, atmospheric distillation, and separator tank. The second text samples in the engineering cases may be hydrogen, hydrogen sulfide, ammonia, a reactor, a heat exchanger, a pipeline, etc.

In some embodiments, the processor may obtain the first text samples in the technical standard through a text recognition algorithm. The text recognition algorithm may include a natural language processing algorithm, a text extraction algorithm, or the like.

The cleaning refers to removing text samples with low relevance to custom words from text samples. The segmenting refers to displaying each word in the text sample individually. A word may be expressed as a text sample. The filtering stop words refers to deleting the stop words in the text samples. The deduplicating refers to removing duplicates from the text samples.

In some embodiments, the technician may clean, segment, filter stop words, and deduplicate the first text samples based on experience.

The technical standard keyword library refers to a database for integrating the processed first text samples.

In some embodiments, the processor may combine the processed first text samples into a database to form the technical standard keyword library.

Step S13, simulating a mechanism model recognition manner and expert experience, obtaining the self-generated technical standard keyword samples according to the technical standard keyword library, and jointly building the mechanism model samples with the second text samples obtained from the engineering cases.

The mechanism model recognition manner refers to a manner for obtaining the self-generated technical standard keyword samples.

In some embodiments, the mechanism model recognition manner may be prior experience and manners for identifying the causes of damage to the pressure equipment.

The technical standard keyword samples refer to words in the first text samples used to build the mechanism model samples.

In some embodiments, the technical standard keyword samples may include some original first text samples in the technical standard keyword library and some self-generated first text samples.

In some embodiments, the processor may perform random sampling on the first text samples in the technical standard keyword library based on the technical standard keyword library to obtain the self-generated technical standard keyword samples. A count of sampling may be a preset count of words. The preset count of words may be preset by the processor based on defaults.

In some embodiments, the processor may also simulate the mechanism model recognition manner and the expert experience, analyze the technical standard keyword library, determine a self-generated quantity of the first text samples for the each damage mode according to a probability that the each damage mode truly occurs, under a premise that the self-generated quantity of the first text samples does not exceed a total count of first text samples in the technical standard keyword library corresponding to the each damage mode, perform sampling on the technical standard keyword library within a preset word quantity range by a conditional random sampling manner, add corresponding damage mode classification labels to sampled texts, perform sample augmentation to obtain the self-generated technical standard keyword samples.

In some embodiments, the processor may analyze the technical standard keyword library based on operating condition cases to determine the actual occurrence probability of the each damage mode.

For example, the processor may obtain a plurality of operating condition cases. For each operating condition case, the processor inputs real-time text data (such as technical standard keyword samples) and real-time operating condition data in the operating condition case into the mechanism model and the operating condition model respectively to determine the comprehensive probabilities of the plurality of damage modes occurring in the operating condition case, and identifies the damage mode with the highest comprehensive probability as the most likely damage mode for the operating condition case. The processor classifies the plurality of operating condition cases according to the most likely damage mode. For each damage mode, the processor may determine the average value of the comprehensive probabilities of the damage mode based on the plurality of comprehensive probabilities of the damage mode occurring in the plurality of operating condition cases, and determine the average value of the plurality of comprehensive probabilities as the actual occurrence probability of the damage mode. More descriptions regarding the real-time text data, the real-time operating condition data, the mechanism model, the operating condition model, and the comprehensive probability may be found in the related descriptions below.

The self-generated quantity refers to a quantity of self-generated first text samples of the damage mode. The self-generation refers to an operation of expanding vocabulary based on semantics of the first text samples.

In some embodiments, the self-generated quantity of the first text samples of the each damage mode is related to the actual occurrence probability of the damage mode.

In some embodiments, the self-generated quantity of the first text samples of the damage mode is less than or equal to the total count of the first text samples in the technical standard keyword library of the damage mode.

In some embodiments, the processor may determine the self-generated quantity based on the actual occurrence probability of the damage mode and the total count of the first text samples corresponding to the damage mode in the technical standard keyword library.

Merely by way of example, the processor may determine the integer obtained by rounding up the product of the actual occurrence probability of the damage mode and the total count of the first text samples corresponding to the damage mode in the technical standard keyword library as the self-generated quantity.

In some embodiments, the processor may self-generate new first text samples based on the first text samples in the technical standard keyword library corresponding to the each damage mode.

For example, the processor may determine synonyms, near-synonyms, etc. of the first text samples based on the first text samples in the technical standard keyword library corresponding to the each damage mode, and determine the synonyms, near-synonyms, etc. as new first text samples self-generated from the first text samples.

The conditional random sampling manner refers to a manner of performing random sampling when preset conditions are met. The preset condition may include that the self-generated quantity of the first text samples does not exceed the total count of the first text samples corresponding to the each damage mode in the technical standard keyword library.

For example, if there are 100 first text samples in the technical standard keyword library corresponding to damage mode 1 and 200 first text samples in the technical standard keyword library corresponding to damage mode 2, the preset condition for recommended random sampling may be that the self-generated quantity of the first text samples does not exceed 100.

In some embodiments, the processor may perform random sampling within the preset word quantity range on the first text samples in the technical standard keyword library corresponding to the each damage mode.

The sampled text refers to the first text samples selected from the technical standard keyword library by the conditional random sampling manner.

The damage mode classification label refers to a label for determining the damage mode classification to which the sampled text belongs.

For example, if the sampled text belongs to corrosion thinning, the damage mode classification label is corrosion thinning.

In some embodiments, the processor may determine the damage mode corresponding to the sampled text based on the sampled text, determine the damage mode classification corresponding to the damage mode by querying a first preset table based on the damage mode, and determine the damage mode classification corresponding to the damage mode as the damage mode classification label of the sampled text. The first preset table may include a relationship between the damage modes and the damage mode classifications. In some embodiments, the first preset table may be preset by the processor based on defaults.

The sample augmentation refers to a manner of increasing the model training dataset. For example, the sample augmentation may be a manner of self-generating the first text samples corresponding to the each damage mode in the technical standard keyword library and performing conditional random sampling to obtain more sampled texts.

In some embodiments, the processor may use the sampled text with the damage mode classification label as the technical standard keyword sample.

In some embodiments, a portion of the self-generated technical standard keyword samples is shown in Table 1 below.

TABLE 1
A portion of the self-generated technical standard keyword samples

| Self-generated technical standard keyword samples | Damage mode |
|---|---|
| Upper head, austenitic stainless steel, fuel gas desulfurization tower, inner | Amine |
| wall, stripper, outside of tube bundle, lean amine buffer tank, lean amine | corrosion |
| cooler, hydrogen-rich gas separation tank, solvent buffer tank, | |
| monoethanolamine, OCr18Ni10Ti | |
| Recovery tower feed, methanation reactor discharge, heat treatment, base | High- |
| material, reaction product, stripper feed, two-stage inlet and outlet materials, | temperature |
| heat exchanger, refinery, H₂S stripper, high temperature, reactor filtration, | hydrogen |
| reaction product heat exchanger, H₂ | corrosion |
| Atmospheric second-line desalted crude oil heat exchanger, 25Cr1Mo0, | Naphthenic |
| atmospheric third stripper cylinder, mixed hydrogen oil, generated oil, | acid corrosion |
| vacuum tower, steam quench oil, stabilized gasoline, casing, initial bottom | |
| residue oil, adsorbent, reaction effluent oil heat exchanger | |
| R301 reaction product, WPL6, metal surface, cylinder, decane, SA515-70, | Wet hydrogen |
| nitric oxide, butene, K302 interstage cooler, C870 bottom oil, cracking, | sulfide |
| aromatic hydrocarbon, Q245R, sulfolane | damage |
| Raw material, chromium, tower bottom, hexane, material selection, cold, | atmospheric |
| penetration, wax oil, naphtha, sulfolane, mixture, pipeline, dome, gas | corrosion - |
| cracking, oil vapor, heptane, lubricating oil, absorption tower, ethylene, | with |
| candle lighting, spray, chloride, condensed water, alkali liquid | insulation |

In some embodiments of the present disclosure, by simulating the mechanism model recognition manner and expert experience, analyzing mechanism knowledge, and adopting the conditional random sampling manner for sampling, the mechanism model samples are self-generated, which solves the problem of insufficient mechanism model samples caused by lack of experience and insufficient personnel, and improves the precision of the prediction results of the mechanism model.

In some embodiments, the processor may obtain the self-generated technical standard keyword samples according to the technical standard keyword library, and jointly build the mechanism model samples with the second text samples obtained from the engineering cases. A portion of the mechanism model samples is shown in Table 2 below:

TABLE 2
A portion of the mechanism model samples

| Mechanism model samples | Damage mode |
|---|---|
| Upper head, austenitic stainless steel, fuel gas desulfurization tower, | Amine corrosion |
| inner wall, stripper, outside of tube bundle, lean amine buffer tank, | (expert sample) |
| lean amine cooler, hydrogen-rich gas separation tank, solvent buffer | |
| tank, monoethanolamine, OCr18Ni10Ti | |
| H₂O, 16MnR, carbon steel, chloride ion, heat exchanger, lean liquid | Amine corrosion |
| cooler, shell side, lean liquid | (engineering cases) |
| Recovery tower feed, methanation reactor discharge, heat treatment, | High-temperature |
| base material, reaction product, stripper feed, two-stage inlet and | hydrogen corrosion |
| outlet materials, heat exchanger, refinery, H₂S stripper, high | (expert sample) |
| temperature, reactor filtration, reaction product heat exchanger, H₂ | |
| C1, C2, SA213GrT11, low alloy steel, 1.25% Cr-0.5% MoH₂, | High-temperature |
| methanation reactor feed, methanation reactor discharge, heat | hydrogen corrosion |
| exchanger, methanation inlet and outlet heat exchanger, heat | (engineering cases) |
| exchange tube | |
| Atmospheric second-line desalted crude oil heat exchanger, | Naphthenic acid |
| 25Cr1Mo0, atmospheric third stripper cylinder, mixed hydrogen oil, | corrosion (expert |
| generated oil, vacuum tower, steam quench oil, stabilized gasoline, | sample) |
| casing, initial bottom residue oil, adsorbent, reaction effluent oil heat | |
| exchanger | |
| 16MnR, carbon steel, aviation kerosene, raw oil, heat exchanger, tube | Naphthenic acid |
| side | corrosion (engineering |
| | cases) |
| R301 reaction product, WPL6, metal surface, cylinder, decane, | Wet hydrogen sulfide |
| SA515-70, nitric oxide, butene, K302 interstage cooler, C870 bottom | damage (expert |
| oil, cracking, aromatic hydrocarbon, Q245R, sulfolane | sample) |
| H₂O, 10#, carbon steel, H₂S, chloride ion, quench oil, water, heat | Wet hydrogen sulfide |
| exchanger, dilution evaporator, heat exchange tube, sulfur-containing | damage (engineering |
| water dilution steam generator, 2# heater | cases) |
| Raw material, chromium, tower bottom, hexane, material selection, | Atmospheric |
| cold, penetration, wax oil, naphtha, sulfolane, mixture, pipeline, | corrosion - with |
| dome, gas cracking, oil vapor, heptane, lubricating oil, absorption | insulation (expert |
| tower, ethylene, candle lighting, spray, chloride, condensed water, | sample) |
| alkali liquid | |
| H₂O, 16MnR, carbon steel, chloride ion, C9+ aromatic hydrocarbon, | Atmospheric |
| water, heat exchanger, C9+ aromatic hydrocarbon water cooler | corrosion - with |
| | insulation |
| | (engineering cases) |

It should be noted that the mechanism model samples are text.

Step S14, retaining the operating condition parameters of preset types in the operating condition data samples and deleting the operating condition parameters of other types to obtain the operating condition big data samples.

The preset types refer to types of preset operating condition parameters. In some embodiments, the preset types of retained operating condition parameters include: pressure, temperature, pH value, H₂S content, H₂O content, CO₂ content, sulfide content, NH₃ content, chloride ion content, or the like. In some embodiments, the technician may also set the preset types of the retained operating condition parameters according to requirements.

In some embodiments, in response to determining that the operating condition data samples do not include one or more media corresponding to the preset types, the processor may set the operating condition parameters corresponding to the preset types to 0.

In some embodiments of the present disclosure, by standardizing operating condition parameters, the integrity of data is ensured. Even if some parameters are not measured or not applicable under specific circumstances, the dataset can still maintain a consistent format, which is convenient for analysis and processing. The operating condition model can adapt to data under different operating conditions, including cases of missing parameters, thereby improving the adaptability and robustness of the operating condition model in practical applications.

The other types refer to types of operating condition parameters other than the preset types. In some embodiments, the processor may determine the types of operating condition parameters other than the preset types as the other types.

In some embodiments, the processor may retain the operating condition parameters of preset types in the operating condition data samples and delete the operating condition data samples with the operating condition parameters of other types to determine the operating condition big data samples.

In some embodiments, a portion of the operating condition big data samples is shown in Table 3.

TABLE 3
A portion of the operating condition big data samples

| | | | | | | | | Chloride | |
|---|---|---|---|---|---|---|---|---|---|
| | | pH | H₂S | H₂O | CO₂ | Sulfide | NH₃ | ion | Damage |
| Pressure | Temperature | value | content | content | content | content | content | content | mode |
| 1.06 | 40 | 7 | 10 | 100 | 6300 | 0 | 0 | 0 | Atmospheric |
| | | | | | | | | | corrosion - |
| | | | | | | | | | without |
| | | | | | | | | | insulation |
| 0.75 | 40 | 8.5 | 2600 | 996100 | 0 | 0 | 1300 | 0 | Wet |
| | | | | | | | | | hydrogen |
| | | | | | | | | | sulfide |
| | | | | | | | | | damage |
| 5.55 | 72 | 7 | 10 | 50 | 0 | 14100 | 0 | 0 | Acidic acid |
| | | | | | | | | | water |
| | | | | | | | | | corrosion |
| 0.78 | 145 | 6.5 | 50 | 1000 | 0 | 500 | 30 | 2 | Hydrochloric |
| | | | | | | | | | acid |
| | | | | | | | | | corrosion |
| 0.4 | 39 | 8.4 | 0 | 1000000 | 0 | 0.1 | 2 | 25 | Cooling |
| | | | | | | | | | water |
| | | | | | | | | | corrosion |

Step S2, using the mechanism model samples and the operating condition big data samples as a dataset for model training, respectively, to build the mechanism model and the operating condition model.

The mechanism model refers to a model used to determine a first possibility. In some embodiments, the mechanism model may be a semantic model or a machine learning model. For example, the mechanism model may include one or a combination of a Convolutional Neural Network (CNN) model, a semantic model, or other custom models.

In some embodiments, an input of the mechanism model may be real-time text data. An output of the mechanism model may be the first possibility that the real-time text data belongs to the various damage modes.

The real-time text data refers to text information monitored in real-time during the operation of the pressure equipment.

In some embodiments, the processor may obtain the real-time text data through a storage device. In some embodiments, the processor may also determine the real-time text data based on input from the technician.

The first possibility refers to a possibility that the real-time text data belongs to a certain damage mode. The first possibility may be represented by a numerical value. The larger the value, the higher the first possibility. In some embodiments, one damage mode corresponds to one first possibility.

In some embodiments, the processor may determine the first possibility that the real-time text data belongs to the various damage modes through the mechanism model based on the real-time text data.

In some embodiments, the processor may divide the mechanism model samples into a training set and a testing set, train the mechanism model based on the training set, and test the trained mechanism model based on the testing set.

In some embodiments, building the mechanism model includes: taking a vector composed of all of the damage mode classification labels in the mechanism model samples; performing vectorization processing on the mechanism model samples using a TF-IDF algorithm to obtain vectorized mechanism model samples, converting the vectorized mechanism model samples into a sparse matrix form; and dividing the vectorized mechanism model samples into a training set and a testing set according to a set proportion, performing model training combined with corresponding damage mode classification label vector, training using a plurality of multi-classification machine learning algorithms, comparing precision, recall, and F1 score of prediction results of a plurality of damage modes under each algorithm of plurality of multi-classification machine learning algorithms, while comparing overall precision, mean value, and weighted mean value of final prediction results for each damage mode by different algorithms in the plurality of multi-classification machine learning algorithms, and selecting an optimal multi-classification machine learning algorithm from the plurality of multi-classification machine learning algorithms to build the mechanism model according to a comparison result.

In some embodiments, the processor may combine all damage mode classification labels in the mechanism model samples into a vector.

For example, the vector may be represented by Y, and the vector expression formula is:

$$\vec{Y} = {( \begin{matrix}{y}_{1} , & {y}_{2} , & {y}_{3} , & … , & {y}_{n}\end{matrix} )}^{T} .$$

where n is a count of classifications of all damage modes, and n>1; yₙ is the n-th damage mode classification label; and the superscript T is the transpose of the matrix.

The Term Frequency-Inverse Document Frequency (TF-IDF) algorithm refers to an algorithm that performs vectorization processing on the mechanism model samples.

The sparse matrix refers to a matrix used to reduce the storage memory of the mechanism model samples.

In some embodiments, the processor may divide the mechanism model samples into the training set and the testing set according to the set proportion. The set proportion may be 80% for the training set and 20% for the testing set.

The multi-classification machine learning algorithm refers to an algorithm used to train the mechanism model. For example, the multi-classification machine learning algorithms may include a logistic regression algorithm, an SVM (Support Vector Machine) algorithm, a random forest algorithm, etc.

The prediction results refer to a prediction of a plurality of damage modes output by the trained mechanism model. For example, the processor may input the testing set into the mechanism model, and the mechanism model outputs the predicted damage modes and first possibilities of a plurality of mechanism model samples. The processor uses the damage modes and first possibilities as the prediction results.

The precision refers to the prediction precision of the damage mode.

In some embodiments, for a predicted damage mode, the processor may input a plurality of mechanism model samples in the testing set into the mechanism model, and the mechanism model outputs the predicted damage modes and corresponding first possibilities of the plurality of mechanism model samples. By comparing with the actual damage modes corresponding to the plurality of mechanism model samples in the testing set, the ratio of the count of correctly predicted mechanism model samples that belong to the damage mode to the total count of mechanism model samples predicted as this damage mode is determined as the precision of the prediction results. A correctly predicted mechanism model sample refers to one where the damage mode predicted by the mechanism model is identical to the actual damage mode of the mechanism model sample in the testing set.

The recall refers to a metric that measures a model's ability to correctly identify samples that are actually positive.

In some embodiments, the processor may determine the recall of the model prediction based on the count of positive samples and the count of false negative samples. The count of positive samples refers to a count of the mechanism model samples for which the predicted damage mode is correct. The count of false negative samples refers to a count of the mechanism model samples where: the damage mode predicted by the model differs from the actual damage mode labeled in the testing set, but technical experts determine that these samples should indeed belong to the damage mode predicted by the model.

For example, the processor may determine the recall of the mechanism model as the ratio of the count of positive samples to the sum of the count of positive samples and the count of false negative samples.

The F1 score refers to a score used to measure model performance.

In some embodiments, the processor may determine the F1 score based on the precision and recall of the model. For example, the F1 score may be expressed by the following equation (1):

$$F 1 score = 2 \times \frac{accuracy \times recall}{accuracy + recall} , \qquad ( 1 )$$

The final prediction result refers to a set of prediction results corresponding to all mechanism model samples in the testing set.

In some embodiments, the processor may integrate the prediction results corresponding to all mechanism model samples in the testing set to determine the final prediction result.

The overall precision refers to the overall precision of the mechanism model.

In some embodiments, the processor may input the testing set into the trained mechanism model, and the trained mechanism model outputs the damage mode and first possibility of the mechanism model sample. The ratio of the count of mechanism model samples with correct predicted damage modes to the total count of mechanism model samples in the testing set is determined as the overall precision.

The mean value refers to an average of the accuracies of the prediction results of all damage modes.

The weighted mean value refers to a weighted average of the accuracies of the prediction results of all damage modes. The weights may be preset by the technician based on experience.

In some embodiments, the processor may compare the mechanism models trained by the plurality of multi-classification machine learning algorithms, and determine the multi-classification machine learning algorithm corresponding to the trained mechanism model with the highest overall precision, mean value, and weighted mean value as the algorithm for training the mechanism model.

The comparison results of the overall precision, mean value, and weighted mean value of the final prediction results of each damage mode by algorithms such as logistic regression, SVM, and random forest are shown in Table 4.

TABLE 4
Comparison results of the overall precision, mean
value, and weighted mean value of three algorithms

| | | | Weighted |
|---|---|---|---|
| Algorithm | Overall precision | Mean value | mean value |
| Logistic regression | 0.7725 | 0.7879 | 0.7720 |
| SVM | 0.7719 | 0.7788 | 0.7707 |
| Random forest | 0.7139 | 0.7233 | 0.7112 |

It can be seen that the logistic regression algorithm has the highest overall precision. Under the logistic regression algorithm, the precision, recall rate, and F1 score of the prediction results for 20 damage modes are shown in Table 5.

TABLE 5
Precision, recall, and F1 score of logistic regression
algorithm for predicting 20 damage modes

| Damage mode | Precision | Recall | F1-Score |
|---|---|---|---|
| Cooling water corrosion | 0.8466 | 0.9857 | 0.9109 |
| Temper embrittlement | 0.9773 | 0.7818 | 0.8687 |
| Atmospheric corrosion (without | 0.7320 | 0.6455 | 0.6860 |
| insulation) | | | |
| Atmospheric corrosion (with | 0.7095 | 0.7664 | 0.7368 |
| insulation) | | | |
| Mechanical fatigue | 0.8904 | 0.8904 | 0.8904 |
| Hydrogen embrittlement | 0.9130 | 0.8936 | 0.9032 |
| Chloride stress corrosion cracking | 0.8482 | 0.8636 | 0.8559 |
| Wet hydrogen sulfide damage | 0.6119 | 0.5062 | 0.5541 |
| Naphthenic acid corrosion | 0.7105 | 0.9101 | 0.7980 |
| Spheroidization | 0.7872 | 0.6271 | 0.6981 |
| Hydrochloric acid corrosion | 1.0000 | 0.8696 | 0.9302 |
| Sulfate stress corrosion cracking | 0.4720 | 0.5784 | 0.5198 |
| Sulfuric acid corrosion | 1.0000 | 1.0000 | 1.0000 |
| Amine stress corrosion cracking | 0.7143 | 0.7843 | 0.7477 |
| Amine corrosion | 0.7297 | 0.6923 | 0.7105 |
| Creep | 0.7143 | 0.8451 | 0.7742 |
| Acidic water corrosion (alkaline | 0.9783 | 0.7759 | 0.8654 |
| sour water) | | | |
| Acidic water corrosion (acidic | 0.6957 | 0.6000 | 0.6443 |
| water) | | | |
| High-temperature hydrogen | 0.7959 | 0.8764 | 0.8342 |
| corrosion | | | |
| High-temperature sulfide corrosion | 1.0000 | 0.6250 | 0.7692 |
| (hydrogen environment) | | | |

In some embodiments of the present disclosure, vectorizing the mechanism model samples and converting them into a sparse matrix form can reduce the storage pressure of the mechanism model and lower the computational load of the mechanism model; training the mechanism model through the plurality of multi-classification machine learning algorithms based on the training set and testing set, and selecting the optimal multi-classification machine learning algorithm from the plurality of multi-classification machine learning algorithms to build the mechanism model by comparing the precision, recall, F1 score of the prediction results, and the overall precision, mean value, and weighted mean value of the final prediction results is conducive to a more comprehensive understanding of the model's performance on different damage modes, ensuring the balance of the model, so as to select the optimal algorithm to build the mechanism model, thereby improving the overall performance of the model.

The operating condition model refers to a model used to determine the second possibility. In some embodiments, the operating condition model may be a classification model or a machine learning model. For example, the operating condition model includes one or a combination of one or more of a CNN model or other custom models, etc.

In some embodiments, an input of the operating condition model may be real-time operating condition data. An output of the operating condition model may be the second possibility that the real-time operating condition data belongs to the various damage modes.

The real-time operating condition data refers to actual measured values and time information of operating condition parameters at a certain moment or within a continuous time period.

In some embodiments, the processor may obtain the real-time operating condition data by performing data preprocessing (including outlier elimination, data cleaning, valid interval screening, time-series smoothing, or the like) on the collected field data, and then selecting the operating condition parameters related to equipment damage. In some embodiments, the processor may also determine the real-time operating condition data based on input from the technician.

The second possibility refers to a possibility that the real-time operating condition data belongs to a certain damage mode. The second possibility may be represented by a numerical value. The larger the value, the higher the second possibility. In some embodiments, one damage mode corresponds to one second possibility.

In some embodiments, the processor may determine the second possibility that the real-time operating condition data belongs to the various damage modes through the operating condition model based on the real-time operating condition data.

In some embodiments, the processor may divide the operating condition big data samples into the training set and the testing set, train the operating condition model based on the training set, and test the trained operating condition model based on the testing set.

In some embodiments, the processor may use the operating condition big data samples as a training set, perform training combined with corresponding damage mode classification label vector, train using a plurality of multi-classification machine learning algorithms, compare precision, recall, and F1 score of prediction results of a plurality of damage modes under each of the plurality of multi-classification machine learning algorithms, while comparing overall precision, mean value, and weighted mean value of final prediction results for each damage mode by different algorithms in the plurality of multi-classification machine learning algorithms, and select an optimal multi-classification machine learning algorithm from the plurality of multi-classification machine learning algorithms to build the operating condition model according to a comparison result.

In some embodiments, the way of that the processor determines the precision, recall, F1 score of the prediction results of the operating condition model, the overall precision, mean value, and weighted mean value of the final prediction results, and selects the optimal multi-classification machine learning algorithm from the plurality of multi-classification machine learning algorithms to build the operating condition model is similar to that of the mechanism model, which will not be repeated here.

In some embodiments, the multi-classification machine learning algorithms used by the processor to train the operating condition model may include a KNN algorithm, a random forest algorithm, a Bernoulli algorithm, etc.

A comparison of the overall precision, mean value, and weighted mean value of the final prediction results of each damage mode by the KNN algorithm (K=6), random forest algorithm, and Bernoulli algorithm is shown in Table 6.

TABLE 6
Comparison of the overall precision, mean value, and
weighted mean value of the plurality of algorithms

| Algorithm | Overall precision | Mean value | Weighted mean value |
|---|---|---|---|
| KNN(K = 6) | 0.4013 | 0.3580 | 0.3829 |
| Random forest | 0.3983 | 0.3669 | 0.3979 |
| Bernoulli | 0.3043 | 0.1249 | 0.2492 |

The precision, recall, and F1 score of the prediction results for 20 damage modes under the KNN algorithm (K=6) are shown in Table 7.

TABLE 7
Precision, recall, and F1 score of KNN algorithm
for predicting 20 damage modes

| Damage mode | Precision | Recall | F1-Score |
|---|---|---|---|
| Cooling water corrosion | 0.6474 | 0.8255 | 0.7257 |
| Temper embrittlement | 0.0909 | 0.0909 | 0.0909 |
| Atmospheric corrosion (without | 0.5399 | 0.4686 | 0.5017 |
| insulation) | | | |
| Atmospheric corrosion (with | 0.4799 | 0.5776 | 0.5242 |
| insulation) | | | |
| Mechanical fatigue | 0.1875 | 0.1154 | 0.1429 |
| Hydrogen embrittlement | 0.2500 | 0.2143 | 0.2308 |
| Chloride stress corrosion | 0.5833 | 0.5072 | 0.5426 |
| cracking | | | |
| Wet hydrogen sulfide damage | 0.1840 | 0.2698 | 0.2188 |
| Naphthenic acid corrosion | 0.7027 | 0.8966 | 0.7879 |
| Spheroidization | 0.4286 | 0.6857 | 0.5275 |
| Hydrochloric acid corrosion | 0.0000 | 0.0000 | 0.0000 |
| Sulfate stress corrosion cracking | 0.1231 | 0.0745 | 0.0928 |
| Sulfuric acid corrosion | 1.0000 | 0.7500 | 0.8571 |
| Amine stress corrosion cracking | 0.0556 | 0.0556 | 0.0556 |
| Amine corrosion | 0.2105 | 0.2759 | 0.2388 |
| Creep | 0.6000 | 0.2045 | 0.3051 |
| Acidic water corrosion (alkaline | 0.0909 | 0.0448 | 0.0600 |
| sour water) | | | |
| Acidic water corrosion (acidic | 0.1250 | 0.0300 | 0.0484 |
| water) | | | |
| High-temperature hydrogen | 0.5238 | 0.6346 | 0.5739 |
| corrosion | | | |
| High-temperature sulfide | 0.8448 | 0.5939 | 0.6975 |
| corrosion (hydrogen | | | |
| environment) | | | |

In some embodiments of the present disclosure, when constructing the mechanism model and the operating condition model, a plurality of multi-classification machine learning algorithms are used, which can make full use of the advantages of different algorithms and improve the generalization ability and prediction precision of the models.

Merely by way of example, after the mechanism model and the operating condition model are constructed, the processor uses 400 second text samples of the engineering cases that have not participated in training (20 for each damage mode) as the testing set of the mechanism model. 400 pieces of operating condition data are used as the testing set of the operating condition model (20 for each damage mode, and there are 9 types of operating condition parameters for each damage mode, including pressure, temperature, pH value, H₂S content, H₂O content, CO₂ content, sulfide content, NH₃ content, and chloride ion content). Based on the output results of the above mechanism model and operating condition model, the processor randomly combines the testing set of the mechanism model and the testing set of the operating condition model belonging to the same damage mode, calls the mechanism model and the operating condition model, and determines the first possibilities P₁₁, P₁₂, P₁₃, . . . , P₁ₙ and the second possibilities P₂₁, P₂₂, P₂₃, . . . , P₂ₙ, n=20 that the results of the testing set of the mechanism model and the testing set of the operating condition model belong to 20 damage modes.

The processor multiplies the first possibility and the second possibility of the same label among the 20 damage modes to obtain P₁=P₁₁×P₂₁, P₂=P₁₂×P₂₂, P₃=P₁₃×P₂₃, . . . , Pₙ=P₁ₙ×Pₙ₂.

In this embodiment, taking a mechanism model sample as an example, the text sample of the mechanism model sample is: [H₂O 16MnR carbon steel water light gasoline heat exchanger stabilizer bottom oil cooler tube side circulating water]. The possibility that this text sample belongs to 20 damage modes is shown in Table 8:

TABLE 8
Possibility of text data belongs to 20 damage modes

| | Possibility |
|---|---|
| | of belonging to |
| Damage mode | the damage mode |
| Cooling water corrosion | 0.579825 |
| Temper embrittlement | 0.002051 |
| Atmospheric corrosion (without insulation) | 0.077043 |
| Atmospheric corrosion (with insulation) | 0.18485 |
| Mechanical fatigue | 0.008226 |
| Hydrogen embrittlement | 0.002475 |
| Chloride stress corrosion cracking | 0.03711 |
| Wet hydrogen sulfide damage | 0.012342 |
| Naphthenic acid corrosion | 0.00799 |
| Spheroidization | 0.003243 |
| Hydrochloric acid corrosion | 0.005774 |
| Sulfate stress corrosion cracking | 0.013135 |
| Sulfuric acid corrosion | 0.007533 |
| Amine stress corrosion cracking | 0.006817 |
| Amine corrosion | 0.006493 |
| Creep | 0.00647 |
| Acidic water corrosion (alkaline sour water) | 0.008517 |
| Acidic water corrosion (acidic water) | 0.012854 |
| High-temperature hydrogen corrosion | 0.010951 |
| High-temperature sulfide corrosion (hydrogen | 0.005841 |
| environment) | |

In Table 8, the damage mode with the highest first possibility for this text sample is Cooling water corrosion, with the first possibility of 0.579825.

This embodiment also takes a piece of operating condition data as an example. The text sample of the operating condition data is: [0.53270100000000025]. The possibility that the operating condition data belongs to 20 damage modes is shown in Table 9.

TABLE 9
Possibility of operating condition
data belonging to 20 damage modes

| | Possibility |
|---|---|
| | of belonging to |
| Damage mode | the damage mode |
| Cooling water corrosion | 0.991667 |
| Temper embrittlement | 0.0 |
| Atmospheric corrosion (without insulation) | 0.008333 |
| Atmospheric corrosion (with insulation) | 0.0 |
| Mechanical fatigue | 0.0 |
| Hydrogen embrittlement | 0.0 |
| Chloride stress corrosion cracking | 0.0 |
| Wet hydrogen sulfide damage | 0.0 |
| Naphthenic acid corrosion | 0.0 |
| Spheroidization | 0.0 |
| Hydrochloric acid corrosion | 0.0 |
| Sulfate stress corrosion cracking | 0.0 |
| Sulfuric acid corrosion | 0.0 |
| Amine stress corrosion cracking | 0.0 |
| Amine corrosion | 0.0 |
| Creep | 0.0 |
| Acidic water corrosion (alkaline sour water) | 0.0 |
| Acidic water corrosion (acidic water) | 0.0 |
| High-temperature hydrogen corrosion | 0.0 |
| High-temperature sulfide corrosion (hydrogen | 0.0 |
| environment) | |

In Table 9, the damage mode with the highest second possibility for the operating condition data text sample is Cooling water corrosion, with the second possibility of 0.9916673.

The processor multiplies the prediction results of the same damage mode in Table 8 and Table 9 to obtain the comprehensive possibility that the pressure equipment belongs to different damage modes, as shown in Table 10.

TABLE 10
Comprehensive possibility of the pressure equipment
belonging to different damage modes

| | Possibility |
|---|---|
| | of belonging to |
| Damage mode | the damage mode |
| Cooling water corrosion | 0.57499 |
| Temper embrittlement | 0.0 |
| Atmospheric corrosion (without insulation) | 0.006420 |
| Atmospheric corrosion (with insulation) | 0.0 |
| Mechanical fatigue | 0.0 |
| Hydrogen embrittlement | 0.0 |
| Chloride stress corrosion cracking | 0.0 |
| Wet hydrogen sulfide damage | 0.0 |
| Naphthenic acid corrosion | 0.0 |
| Spheroidization | 0.0 |
| Hydrochloric acid corrosion | 0.0 |
| Sulfate stress corrosion cracking | 0.0 |
| Sulfuric acid corrosion | 0.0 |
| Amine stress corrosion cracking | 0.0 |
| Amine corrosion | 0.0 |
| Creep | 0.0 |
| Acidic water corrosion (alkaline sour water) | 0.0 |
| Acidic water corrosion (acidic water) | 0.0 |
| High-temperature hydrogen corrosion | 0.0 |
| High-temperature sulfide corrosion (hydrogen | 0.0 |
| environment) | |

The processor sorts the comprehensive possibilities P₁₁, P₂, P₃, . . . , Pₙ belonging to each damage mode in Table 10 in descending order. The damage mode with the largest comprehensive possibility, “Cooling water corrosion”, is the most likely damage mode. At the same time, for the engineering cases where the same second text sample points to a plurality of damage modes, the processor provides the top three damage modes M₁, M₂, M₃ with the top three largest comprehensive possibilities as the most likely damage modes to occur in the pressure equipment. Due to the presence of a comprehensive possibility of 0, the processor determines the top three damage modes with the highest comprehensive possibilities as follows: M₁ is Cooling water corrosion, M₂ is atmospheric corrosion (without insulation), and M₃ is empty. With P_{M1}=0.57499, P_{M2}=0.00642 and P_{M3}=0, the actual damage mode in the training set is Cooling water corrosion, and M₁ (Cooling water corrosion) appears in the top three predicted damage modes, achieving accurate prediction. In addition, the processor compares the damage modes predicted based on the 400 testing sets with the actual damage modes, and the final precision rate is 85.2130%.

Step S3, inputting real-time text data to be predicted and real-time operating condition data into the mechanism model and the operating condition model respectively, calculating a first possibility that the real-time text data belongs to each of the plurality of damage modes, and a second possibility that the real-time operating condition data belongs to the each of the plurality of damage modes, generating an equipment damage monitoring result based on the first possibility and the second possibility.

In some embodiments, the processor may screen the real-time operating condition data to be input into the operating condition model based on an operating condition type, fluctuation amplitude and fluctuation frequency of fluctuating operating conditions.

The operating condition type refers to label information that classifies the operating environment of the pressure equipment according to the combination of parameters such as the property of the medium involved in the actual operation of the pressure equipment (e.g., acidic, alkaline, sulfur-containing, hydrogen-containing, etc.), temperature, pressure, and flow rate. For example, the operating condition type includes “acidic medium flow”, “high-temperature and high-pressure hydrogen environment”, or the like.

The fluctuating operating conditions refer to numerical changes of each piece of operating condition data within a preset time window. In some embodiments, the fluctuating operating conditions may include the fluctuation amplitude and the fluctuation frequency.

The fluctuation amplitude refers to a difference between the maximum measured value and the minimum measured value of the operating condition parameter within a preset time window. The fluctuation amplitude may be expressed as a numerical value. The larger the value, the greater the fluctuation amplitude.

The fluctuation frequency refers to a count of times the fluctuation amplitude of the operating condition parameter exceeds a preset amplitude threshold within a unit time.

In some embodiments, after obtaining the real-time operating condition data, the processor may first classify the real-time operating condition data into a plurality of groups according to the operating condition type (e.g., the process section where the pressure equipment is located, the type of medium it is in); perform fluctuation analysis on each group of the real-time operating condition data using a preset data sampling interval and a preset time window (e.g., 1 hour or 30 minutes) to obtain the fluctuation amplitude and fluctuation frequency of each group of data. If the fluctuation amplitude of a group of data exceeds the preset amplitude threshold or the fluctuation frequency exceeds the frequency threshold, the group of the real-time operating condition data needs to be input into the operating condition model.

In some embodiments of the present disclosure, screening the real-time operating condition data to be input into the operating condition model based on the operating condition type, the fluctuation amplitude and fluctuation frequency of the fluctuating operating conditions is conducive to reducing the amount of data processed by the operating condition model, screening operating condition data highly related to the damage modes, and improving the prediction relevance and precision of the operating condition model.

The equipment damage monitoring result refers to a damage mode with the highest comprehensive possibility.

In some embodiments, the processor may sort the first possibilities that the real-time text data belongs to the damage mode, the second possibilities that the real-time operating condition data belongs to the damage mode, and the comprehensive possibilities that the pressure equipment belongs to the damage mode respectively from large to small, and take the top three damage modes and the comprehensive possibilities as the equipment damage monitoring results.

In some embodiments, in response to determining that the comprehensive possibility of the damage mode in the equipment damage monitoring result is greater than a possibility threshold, the safe operation parameters are retrieved and determined based on the equipment damage monitoring result through a vector database. Then the safe operation parameters are sent to the pressure equipment. For example, the safe operation parameters may include medium temperature, cooling water flow rate, process medium feed ratio, etc., of the pressure equipment.

The possibility threshold refers to a minimum comprehensive possibility required to query the safe operation threshold. For example, the possibility threshold is 50%.

In some embodiments, the possibility threshold may be preset by the processor based on defaults.

The safe operation parameters refer to parameters that ensure the safe operation of the pressure equipment without further damage or affecting the normal operation of other pressure equipment. For example, the safe operation parameters may include maximum allowable pressure, allowable temperature range, allowable upper limit of H₂S content, etc.

In some embodiments, the processor may determine the safe operation parameters by retrieving the vector database based on the equipment damage monitoring result. The vector database may include a relationship between the equipment damage monitoring results and the safe operation parameters. In some embodiments, the processor may select historical operating records of the pressure equipment that operated safely after damage. For each record, the equipment type of the pressure equipment, the corresponding real-time operating condition parameters (including pressure, temperature, pH value, H₂S content, etc.), and the equipment damage monitoring result are converted into feature vectors. The processor stores the safe operation parameters actually selected subsequently corresponding to each feature vector.

For example, the processor may generate a query vector based on the equipment type of the current pressure equipment, the corresponding real-time operating condition parameters (including pressure, temperature, pH value, H₂S content, etc.), and the equipment damage monitoring result, input the query vector into the vector database, retrieve the feature vector with the highest similarity to the query vector, and output the safe operation parameters associated with the feature vector. The similarity calculation manner may include, but is not limited to, Euclidean distance and cosine similarity.

As another example, the processor may also use the weighted mean value of a plurality of feature vectors with the highest similarity as the safe operation parameter.

It should be noted that the vector database may also include real-time operating conditions. Due to the variety of the pressure equipment types and the plurality of damage modes, even for the same pressure equipment, under different damage modes, the real-time operating conditions (such as pressure, temperature, H₂S content) are different, and the corresponding safe operation parameters are also different (for example, “high-temperature hydrogen corrosion” is most sensitive to temperature and focuses more on the operating temperature value; “Wet hydrogen sulfide damage” is most sensitive to H₂S content and focuses more on H₂S content). Therefore, there are many combinations of corresponding safe operation parameters, which may be retrieved through vector database matching. Under the same damage mode, different real-time operating conditions may lead to differences in the current damage degree of the pressure equipment, so the corresponding safe operation parameters are also set differently.

In some embodiments, the processor may control the safe operation of the pressure equipment in a plurality of ways.

For example, for the pressure equipment (e.g., heat exchangers, pressure vessels, towers, etc.), the processor may control the safe operation of the pressure equipment by changing the valve opening to adjust the pressure, changing the cooling water flow to adjust the temperature, and changing the feed ratio to adjust the H₂S content.

As another example, the processor may first determine the temperature difference between the current real-time temperature of the pressure equipment and the temperature in the safe operation parameters, determine the amount of heat that needs to be removed based on the temperature difference, then determine the required target flow rate of cooling water according to the flow-heat exchange curve and the amount of heat that needs to be removed, and finally adjust the opening of the cooling water valve to make the actual cooling water flow rate reach the target flow rate, thereby reducing the temperature of the pressure equipment to the temperature in the safe operation parameters by cooling water. The flow-heat exchange curve may reflect the corresponding relationship between the cooling water flow and the amount of heat that is removed. The flow-heat exchange curve may be obtained by the technician based on practical operational experience.

In some embodiments of the present disclosure, sending the safe operation parameters to the pressure equipment and instructing the pressure equipment to adjust the opening of the pressure valve, the opening of the cooling water valve, and the feed ratio is conducive to preventing further development of equipment damage, reducing unexpected shutdowns and maintenance costs, avoiding safety accidents caused by equipment damage, ensuring the safety of personnel and equipment, and optimizing the operating efficiency and performance of the pressure equipment.

In some embodiments, the processor may collect the field data of the pressure equipment through sensors and generate the real-time operating condition data of the pressure equipment based on the field data; generate the fluctuating operating conditions according to the real-time operating condition data at continuous time points; and determine the equipment to be monitored according to the fluctuating operating conditions, control the monitoring device to start, and collect the field data of the equipment to be monitored based on preset monitoring parameters.

In some embodiments, the processor may segment the real-time operating condition data collected at continuous time points for the same pressure equipment according to a preset time window (e.g., 1 hour or 30 minutes); determine the fluctuation amplitude of each operating condition parameter within each time window. In the same window, the processor may compare the fluctuation amplitude in the continuous time points with the amplitude threshold, count a count of times exceeding the amplitude threshold to obtain the fluctuation frequency of the operating condition parameter. The processor summarizes the fluctuation amplitude and fluctuation frequency of each operating condition parameter in each time window to form the fluctuating operating conditions of the pressure equipment.

The equipment to be monitored refers to the pressure equipment that needs further damage monitoring.

In some embodiments, the processor may define an amplitude threshold and a frequency threshold for each key operating condition parameter in a preset table; determine and update the fluctuating operating condition of each pressure equipment in real-time. For any pressure equipment, as long as the fluctuation amplitude of any of the operating condition parameters within the time window is greater than the corresponding amplitude threshold or the fluctuation frequency is greater than the corresponding frequency threshold, the equipment is determined as the equipment to be monitored.

In some embodiments, the processor may also determine the equipment to be monitored according to the fluctuation amplitude and fluctuation frequency of the fluctuating operating conditions, as well as the damage type.

For example, the processor defines the amplitude threshold and frequency threshold for each key operating condition parameter in a preset table; determines and updates the fluctuating operating condition of each equipment in real-time. For any equipment, as long as the fluctuation amplitude of any of the operating condition parameters within the time window is greater than the corresponding amplitude threshold or the fluctuation frequency is greater than the corresponding frequency threshold, and the predicted damage mode classification belongs to a preset kcy monitoring type (such as corrosion thinning, hydrogen embrittlement), the equipment is determined as the equipment to be monitored.

In some embodiments of the present disclosure, determining the equipment to be monitored based on the fluctuation amplitude, fluctuation frequency, and damage type is conducive to ensuring that monitoring resources are allocated to the equipment that most needs monitoring, avoiding resource waste, improving the overall efficiency of the monitoring system, and more accurately predicting which equipment may face damage risks, thereby taking preventive measures in advance.

In some embodiments, in response to determining that the pressure equipment is the equipment to be monitored, the processor sends a start instruction to the monitoring device configured on the equipment to be monitored, which performs high-precision data collection according to the preset monitoring parameters after starting.

The preset monitoring parameters may include sampling frequency, sampling duration, sampling points, collection resolution, and types of target physical quantities (e.g., wall thickness, corrosion rate, local temperature gradient, local stress distribution, etc.). In some embodiments, the preset monitoring parameters may be used to supplement the operating information not covered or with insufficient precision by the aforementioned basic sensors.

The monitoring device refers to a detection unit with higher precision. In some embodiments, compared with the field data collected by sensors, the field data collected by the monitoring device has higher precision. The monitoring device is usually in a non-working state and is only activated to monitor the equipment to be monitored when the fluctuating operating conditions exceed the limit and the equipment is determined as the equipment to be monitored.

In some embodiments of the present disclosure, determining the equipment to be monitored according to the fluctuating operating conditions, controlling the monitoring device to start, and collecting the field data of the equipment to be monitored based on preset monitoring parameters can enable more targeted monitoring, improve monitoring precision, allow the system to dynamically respond to changes in the state of the pressure equipment, reduce manual intervention, improve monitoring efficiency, and reduce labor costs.

In some embodiments, the operating condition parameters also include an additional operating condition parameter. The processor may judge whether to monitor the equipment to be monitored in the future time period based on the additional operating condition parameter. The processor controls the sensor corresponding to the equipment to be monitored to monitor or stop monitoring based on the judgment result.

The additional operating condition parameter refers to the operating condition parameter(s) with the highest relevance to the current equipment type and current operating condition type, extracted from the field data collected after the monitoring device is activated, such as local wall thickness, local corrosion rate, and local vibration characteristics. In some embodiments, the relevance may be determined by the processor by querying a second preset table based on the equipment type, operating condition type, and operating condition parameters. The second preset table may include a relationship between equipment type, operating condition type, operating condition parameters, and the relevance. In some embodiments, the second preset table may be preset by the processor based on defaults.

For example, when the equipment type is “pipeline” and the operating condition type is “acidic medium flow”, the operating condition parameter “local corrosion rate” has the highest relevance to “pipeline” and “acidic medium flow”, so the additional operating condition parameter may be “local corrosion rate”, etc.

As another example, when the equipment type is “pressure vessel” and the operating condition type is “high-temperature and high-pressure hydrogen environment”, the operating condition parameter “local wall thickness” has the highest relevance to “pressure vessel” and “high-temperature and high-pressure hydrogen environment”, so the additional operating condition parameter may be “local wall thickness”, etc.

In some embodiments, after obtaining the additional operating condition parameter, the processor may compare the additional operating condition parameter with the corresponding preset operating condition safety range. If a value of the additional operating condition parameter has exceeded the preset operating condition safety range, it is necessary to continue damage monitoring on the equipment to be monitored in the future.

In some embodiments of the present disclosure, judging whether to monitor the equipment to be monitored in the future time period based on the additional operating condition parameter, and further controlling the sensor corresponding to the equipment to be monitored to monitor or stop monitoring can avoid continuous monitoring of all pressure equipment, thereby saving resources, improving monitoring efficiency, and reducing unnecessary monitoring activities.

In some embodiments, the processor may predetermine a future time point for activating the model according to the equipment damage monitoring result and additional operating condition parameter. In response to determining that a time point reaches the future time point, the processor may input the real-time text data and real-time operating condition data at the time point into the mechanism model and the operating condition model, respectively, to generate the equipment damage monitoring result again. The processor determines whether to issue an equipment early warning according to a plurality of equipment damage monitoring results corresponding to the same equipment. In response to determining to issue an equipment early warning, the processor may control a warning device to turn on and control a specified pressure equipment to operate according to the safe operation parameters.

In some embodiments, the processor may analyze the equipment damage monitoring result, and query a third preset table to determine a time interval for the next activation of the mechanism model and the operating condition model according to the top-ranked damage modes in the comprehensive possibility set and their possibility values, the corresponding preset damage thresholds, additional operating condition parameters (e.g., wall thickness, local corrosion rate, vibration amplitude, etc.), and the corresponding preset operating condition safety ranges.

The third preset table may include a relationship between the damage modes, possibilities, preset damage thresholds, additional operating condition parameters, preset operating condition safety ranges, and model activation time intervals.

In some embodiments, the third preset table may be constructed based on historical equipment monitoring records with good monitoring effects. For example, the processor may collect a large number of historical equipment monitoring records with good monitoring effects. Each record includes: the damage mode of the identified equipment and the corresponding possibility value, the preset damage threshold corresponding to the damage mode, the additional operating condition parameters collected in the same period, the preset operating condition safety range of the additional operating condition parameters, and the actual model activation time interval subsequent to the record. The processor fills various data into the third preset table for query during operation.

In some embodiments, the processor may determine the future time point based on the current time point and the time interval for the next activation of the mechanism model and the operating condition model.

The equipment early warning refers to an operation of issuing an early warning for the pressure equipment that may be damaged.

In some embodiments, the processor may determine a growth trend of the equipment damage result based on the plurality of equipment damage monitoring results corresponding to the same pressure equipment at different time points, and trigger the equipment early warning when the growth trend is increasing or the number of times that the possibility exceeding the possibility threshold reaches a number threshold. The number threshold refers to the minimum number of times that the possibility exceeds the possibility threshold to trigger the equipment early warning. The growth trend refers to a growth trend of the possibility value. For example, the growth trend may include increasing and decreasing.

For example, the processor may obtain a plurality of equipment damage monitoring results of the pressure equipment at different time points within a period of time, judge whether the possibility in the equipment damage monitoring results of the pressure equipment continues to increase or decrease over time within the period, and trigger the equipment early warning if the possibility continues to increase over time.

As another example, the processor may obtain the equipment damage monitoring result of the pressure equipment in real-time, and trigger the equipment early warning if the possibility in the equipment damage monitoring result at the current time point exceeds the possibility threshold.

The warning device may include a warning light, a warning sound, or the like.

In some embodiments of the present disclosure, determining the future time point for activating the model, inputting the real-time text data and real-time operating condition data at the corresponding time point into the mechanism model and the operating condition model respectively to generate the equipment damage monitoring result again, determining whether to issue the equipment early warning according to the plurality of equipment damage monitoring results corresponding to the same equipment, and further controlling the warning device to turn on and controlling the specified pressure equipment to operate according to the safe operation parameters can issue an early warning before damage occurs, thereby taking preventive measures and reducing downtime losses caused by equipment failures.

In some embodiments of the present disclosure, the analysis results of the mechanism model and the operating condition model are combined, rather than merely focusing on a single evaluation criterion. By deeply understanding the advantages of the mechanism model and the operating condition model, the potential correlation between mechanism analysis and operating condition analysis factors is revealed, and finally, a more comprehensive and accurate equipment damage mode evaluation model is provided. The equipment damage monitoring results are generated by using the to-be-predicted mechanism model sample data and real-time operating condition data, which effectively improves the utilization rate of real-time information and makes the monitoring results more accurate.

In some embodiments of the present disclosure, when constructing the mechanism model, the technical standard and engineering cases are included. The technical standard and engineering cases describe information such as the damage mechanism, influencing factors, and design specifications of the equipment. The information in the engineering cases includes data collected in real-time during the operation of the equipment. After comprehensively considering the above two aspects, when constructing the mechanism model, a plurality of influencing factors from standards and the field can be taken into account, resulting in a more comprehensive mechanism model and expanding the applicability of the model.

Some embodiments of the present disclosure can solve the problem that the mechanism model cannot process non-text data when dealing with the operating condition big data. By collecting operating condition parameters closely related to equipment damage (e.g., temperature, pressure, pH value, etc.), converting these digital data into an analyzable form, and constructing the operating condition model, the limitations of identifying the damage modes solely based on standard definitions are compensated. At the same time, the important role of operating condition parameters in equipment damage monitoring is reflected.

Some embodiments of the present disclosure have the advantages of intelligence, timeliness, and early warning. Without a large amount of manual operation, through real-time monitoring and analysis of equipment status, abnormal situations or potential equipment damage can be promptly warned to operators or related management systems. Corresponding measures can be taken to avoid risks before equipment failures or damage occur, thereby reducing maintenance costs and improving the reliability of the equipment.

### Example 2

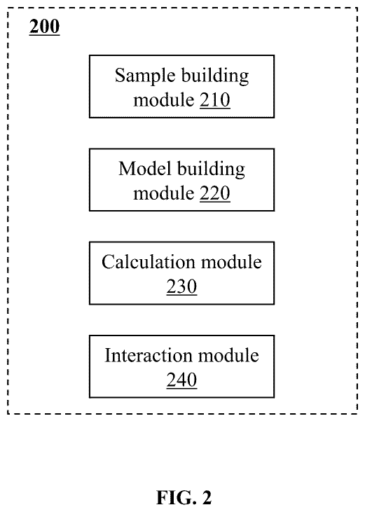

FIG. 2 is an exemplary framework diagram illustrating a system for intelligent monitoring of equipment damage based on mechanism and operating condition big data according to Example 2 of the present disclosure.

In some embodiments, as shown in FIG. 2, a system 200 for intelligent monitoring of equipment damage based on mechanism and operating condition big data includes a sample building module 210, a model building module 220, and a calculation module 230.

The sample building module 210 is configured to set the plurality of damage modes of the pressure equipment, build the mechanism model samples for the each damage mode based on the technical standard and the engineering cases, and build the operating condition big data samples for the each damage mode based on the field data.

The sample building module 210 is further configured to obtain the mechanism model samples describing the each damage mode from the technical standard and the engineering cases, and obtain operating condition data samples describing the each damage mode from the field data; clean, segment, filter stop words, and deduplicate first text samples obtained from the technical standard according to the custom dictionary and the stop words list to obtain a technical standard keyword library; simulate a mechanism model recognition manner and expert experience, obtain self-generated technical standard keyword samples according to the technical standard keyword library, and jointly build the mechanism model samples with second text samples obtained from the engineering cases; and retain operating condition parameters of preset types in the operating condition data samples and delete operating condition parameters of other types to obtain the operating condition big data samples.

The model building module 220 is configured to use the mechanism model samples and the operating condition big data samples as the dataset for model training, respectively, to build the mechanism model and the operating condition model.

The model building module 220 is further configured to take a vector composed of all of the damage mode classification labels in the mechanism model samples as Y, expressed by a formula \vec{Y}=(y₁, y₂, y₃, . . . , yₙ)^{T}, where n is a total count of the plurality of damage modes, n>1; yₙ is a n-th damage mode classification label; a superscript T is a transpose of a matrix; perform vectorization processing on the mechanism model samples using a TF-IDF algorithm to obtain vectorized mechanism model samples, convert the vectorized mechanism model samples into a sparse matrix form; and divide the vectorized mechanism model samples into a training set and a testing set according to a set proportion, perform model training combined with corresponding damage mode classification label vector, train using a plurality of multi-classification machine learning algorithms, compare precision, recall, and F1 score of prediction results of a plurality of damage modes under each of the plurality of multi-classification machine learning algorithms, while comparing overall precision, mean value, and weighted mean value of final prediction results for each damage mode by different algorithms in the plurality of multi-classification machine learning algorithms, and select an optimal multi-classification machine learning algorithm from the plurality of multi-classification machine learning algorithms to build the mechanism model according to a comparison result.

The model building module 220 is further configured to use the operating condition big data samples as a training set, perform training combined with corresponding damage mode classification label vector, train using a plurality of multi-classification machine learning algorithms, compare precision, recall, and F1 score of prediction results of a plurality of damage modes under each of the plurality of multi-classification machine learning algorithms, while comparing overall precision, mean value, and weighted mean value of final prediction results for each damage mode by different algorithms in the plurality of multi-classification machine learning algorithms, and select an optimal multi-classification machine learning algorithm from the plurality of multi-classification machine learning algorithms to build the operating condition model according to a comparison result.

The calculation module 230 is configured to input the real-time text data to be predicted and the real-time operating condition data into the mechanism model and the operating condition model respectively, calculate the first possibility that the real-time text data belongs to the each of the plurality of damage modes, and the second possibility that the real-time operating condition data belongs to the each of the plurality of damage modes, and generate the equipment damage monitoring result based on the first possibility and the second possibility.

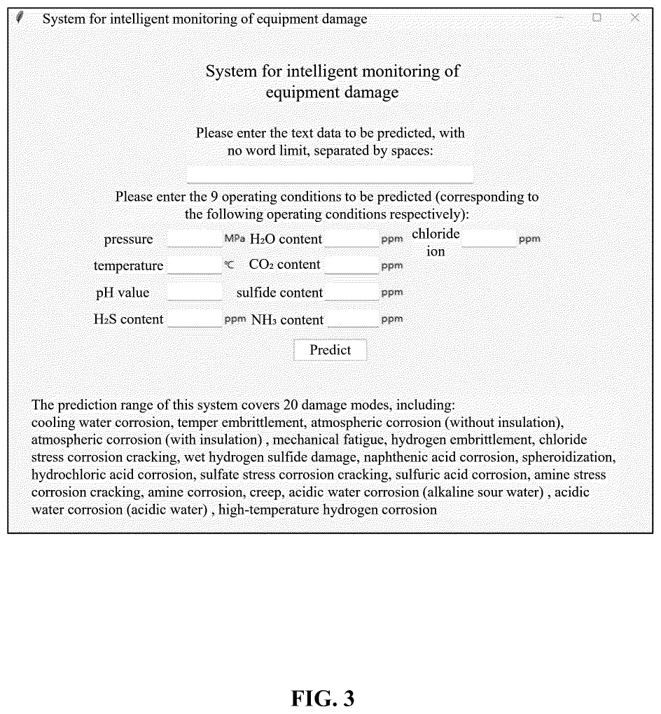

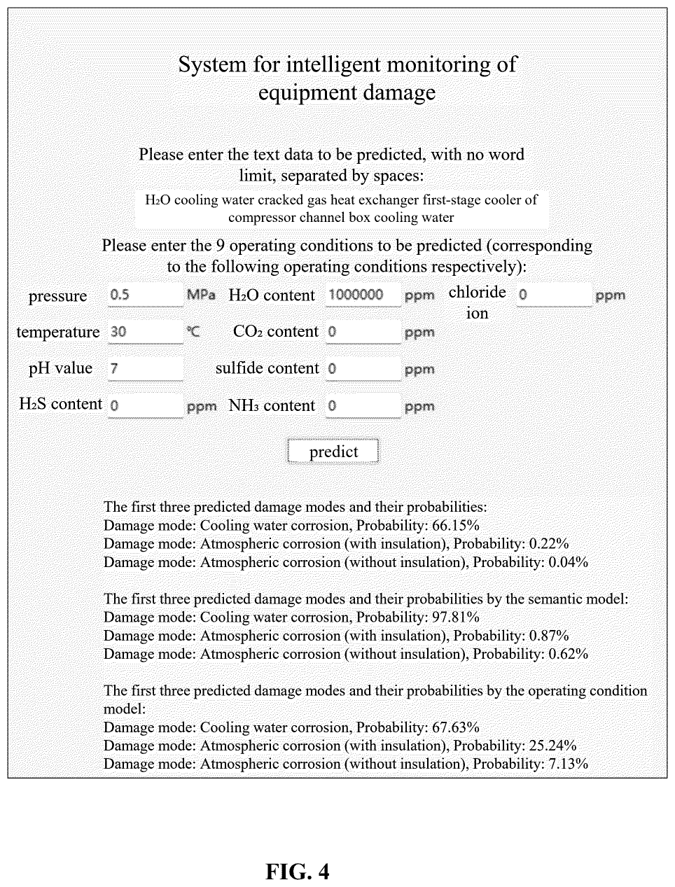

In this embodiment, the system for intelligent monitoring of equipment damage may further include an interaction module 240, which visually displays the operation process and prediction results. Referring to FIG. 3 and FIG. 4, FIG. 3 is a display diagram illustrating an input visualization interface of a system for intelligent monitoring of equipment damage according to some embodiments of the present disclosure, and within the range of 20 damage modes, text and operating conditions need to be input in the boxes respectively. FIG. 4 is a display diagram illustrating an operation and result interface of a system for intelligent monitoring of equipment damage according to some embodiments of the present disclosure, showing the top three damage modes of the final prediction, the top three damage modes predicted by the mechanism model, and the top three damage modes predicted by the operating condition model, together with their corresponding prediction probabilities.

### Example 3

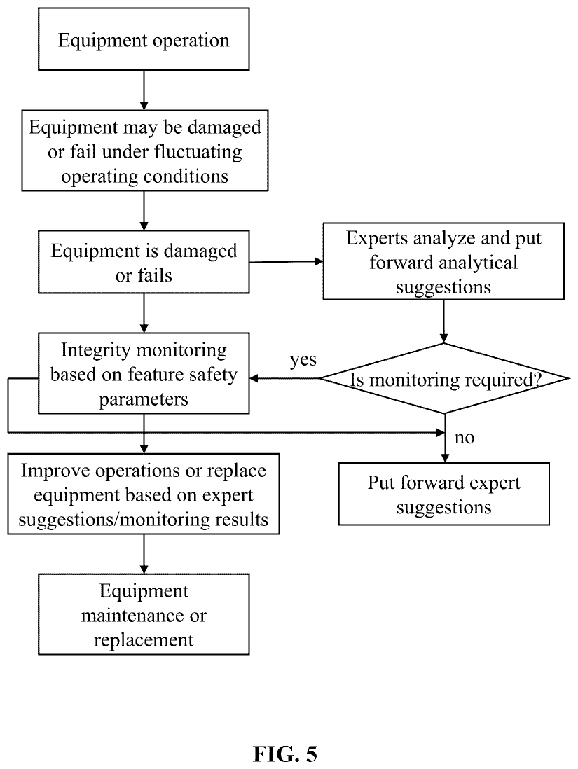

FIG. 5 is a logic diagram illustrating a traditional passive risk prevention and control manner for pressure equipment.

Referring to FIG. 5, the figure is a logic diagram of the traditional passive risk prevention and control manner. It can be seen that the manner only detects damage that has occurred, and cannot automatically identify and warn when damage to operating equipment occurs. On the other hand, a count of the pressure equipment is huge, and manual analysis is time-consuming and labor-intensive. The low degree of intelligence makes it impossible to carry out large-scale automatic damage analysis, which seriously affects the safe and long-term operation of the pressure equipment.

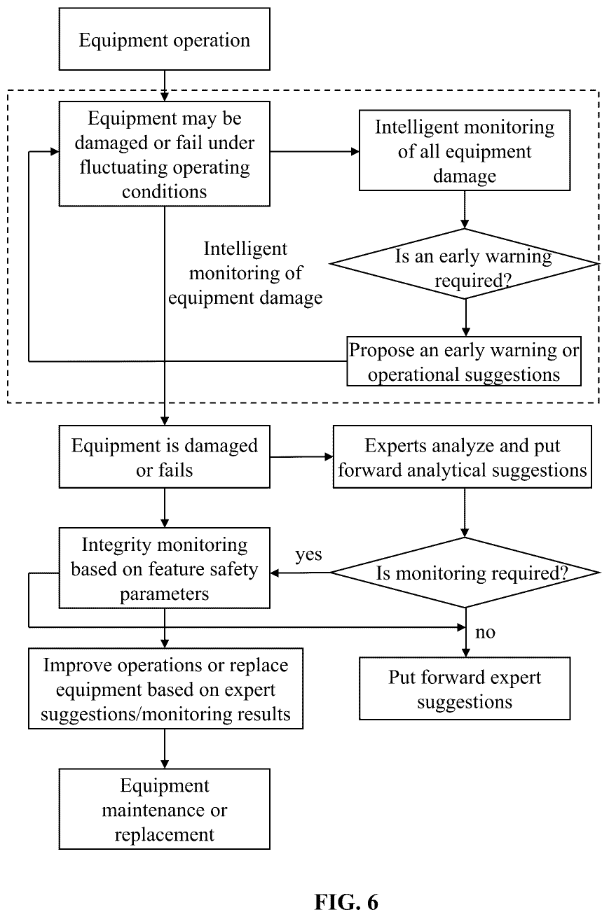

FIG. 6 is a logic diagram illustrating an active risk prevention and control manner for pressure equipment according to some embodiments of the present disclosure.

In order to solve the above problem, this embodiment provides an active risk prevention and control manner for the pressure equipment. Referring to FIG. 6, the active risk prevention and control manner for the pressure equipment provided in this embodiment includes the following steps:

Step 1, performing intelligent damage monitoring on all equipment when the pressure equipment is in operation and subject to fluctuating operating conditions.

The intelligent damage monitoring in Step 1 may be implemented using the method for intelligent monitoring of equipment damage based on mechanism and operating condition big data in Example 1, or directly apply the system for intelligent monitoring of equipment damage in Example 2 to obtain the equipment damage monitoring result.

Step 2, determining whether it is necessary to issue an early warning for the equipment according to the equipment damage monitoring result obtained in Step 1. When it is necessary to issue an early warning for the equipment, the processor puts forward an early warning or operation suggestion, and continues to perform intelligent damage monitoring on all equipment.

It can be seen that the active risk prevention and control manner disclosed in this embodiment has the advantages of intelligence, timeliness, and early warning. Without a large amount of manual operation, through real-time monitoring and model analysis of equipment status, abnormal situations or potential equipment damage can be promptly warned to operators or related management systems. Corresponding measures can be taken to avoid risks before equipment failures or damage occur, thereby reducing maintenance costs and improving the reliability of the equipment.

It should be noted that the above descriptions are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

What is claimed is:

1. A method for intelligent monitoring of equipment damage based on mechanism and operating condition big data, wherein the method is used for monitoring damage modes of pressure equipment, the method comprises:
setting a plurality of damage modes of the pressure equipment, building mechanism model samples for each damage mode based on a technical standard and engineering cases, and building operating condition big data samples for the each damage mode based on field data;
before building the operating condition big data samples, building a custom dictionary and a stop words list related to the plurality of damage modes of the pressure equipment;
wherein building the mechanism model samples and building the operating condition big data samples includes:
obtaining the mechanism model samples describing the each damage mode from the technical standard and the engineering cases, and obtaining operating condition data samples describing the each damage mode from the field data;
cleaning, segmenting, filtering stop words, and deduplicating first text samples obtained from the technical standard according to the custom dictionary and the stop words list to obtain a technical standard keyword library;
simulating a mechanism model recognition manner and expert experience, obtaining self-generated technical standard keyword samples according to the technical standard keyword library, and jointly building the mechanism model samples with second text samples obtained from the engineering cases; and
retaining operating condition parameters of preset types in the operating condition data samples and deleting operating condition parameters of other types to obtain the operating condition big data samples;
using the mechanism model samples and the operating condition big data samples as a dataset for model training, respectively, to build a mechanism model and an operating condition model; and
inputting real-time text data to be predicted and real-time operating condition data into the mechanism model and the operating condition model respectively, calculating a first possibility that the real-time text data belongs to each of the plurality of damage modes, and a second possibility that the real-time operating condition data belongs to the each of the plurality of damage modes, generating an equipment damage monitoring result based on the first possibility and the second possibility;
a first possibility set P(1) that the real-time text data belongs to the each of the plurality of damage modes is expressed as: P(1)={P₁₁, P₁₂, P₁₃, . . . , Pᵢₙ}; a second possibility set P(2) that the real-time operating condition data belongs to the each of the plurality of damage modes is expressed as: P(1)={P₂₁, P₂₂, P₂₃, . . . , P₂ₙ}, where P₁ₙ denotes a first possibility that the real-time text data belongs to a n-th damage mode; and Pₙ₂ denotes a second possibility that the real-time operating condition data belongs to the n-th damage mode;
multiplying the first possibility and the second possibility that the real-time text data and the real-time operating condition data belong to a same damage mode to obtain a comprehensive possibility set {P₁, P₂, P₃, . . . , P)} that the pressure equipment belongs to the each damage mode; wherein P₁=P₁₁×P₂₁, P₂=P₁₂×P₂₂, P₃=P₁₃×P₂₃, . . . , Pₙ=P₁ₙ×P₂ₙ; wherein, sorting possibilities in the first possibility set P(1), possibilities in the second possibility set P(2), and possibilities in the comprehensive possibility set, respectively, from large to small, and taking top-ranked damage modes and possibilities of the top-ranked damage modes as the equipment damage monitoring result.

2. The method according to claim 1, wherein the technical standard adopts GB/T30579 technical standard; the GB/T30579 technical standard includes a damage mechanism, a damage morphology, a main influencing factor, a device or equipment prone to damage, and a main preventive measure of a damage mode; and the engineering cases include material names, media, and names of parts where damages occurred.

3. The method according to claim 1, wherein the preset types include: pressure, temperature, pH value, H₂S content, H₂O content, CO₂ content, sulfide content, NH₃ content, and chloride ion content; and when one or more media are not present or not provided, setting an operating condition parameter corresponding to the one or more media to 0.

4. The method according to claim 1, wherein obtaining the technical standard keyword samples includes:
simulating the mechanism model recognition manner and the expert experience, analyzing the technical standard keyword library, determining a self-generated quantity of the first text samples for the each damage mode according to a probability that the each damage mode truly occurs, under a premise that the self-generated quantity of the first text samples does not exceed a total count of first text samples in the technical standard keyword library corresponding to the each damage mode, performing sampling on the technical standard keyword library within a preset word quantity range by a conditional random sampling manner, adding corresponding damage mode classification labels to sampled texts, performing sample augmentation to obtain the self-generated technical standard keyword samples.

5. The method according to claim 4, wherein building the mechanism model includes:
taking a vector composed of all of the damage mode classification labels in the mechanism model samples as Y, expressed by a formula \vec{Y}=(y₁, y₂, y₃, . . . yₙ)^{T},
where n is a total count of the plurality of damage modes, n>1; y₁ is a n-th damage mode classification label; a superscript T is a transpose of a matrix;
performing vectorization processing on the mechanism model samples using a TF-IDF algorithm to obtain vectorized mechanism model samples, converting the vectorized mechanism model samples into a sparse matrix form; and
dividing the vectorized mechanism model samples into a training set and a testing set according to a set proportion, performing model training combined with a corresponding damage mode classification label vector training using a plurality of multi-classification machine learning algorithms, comparing precision, recall, and F1 score of prediction results of a plurality of damage modes under each of the plurality of multi-classification machine learning algorithms, while comparing overall precision, mean value, and weighted mean value of final prediction results for each damage mode by different algorithms in the plurality of multi-classification machine learning algorithms, and selecting an optimal multi-classification machine learning algorithm from the plurality of multi-classification machine learning algorithms to build the mechanism model according to a comparison result.

6. The method according to claim 5, wherein building the operating condition model includes:
using the operating condition big data samples as a training set, performing training combined with a corresponding damage mode classification label vector, training using a plurality of multi-classification machine learning algorithms, comparing precision, recall, and F1 score of prediction results of a plurality of damage modes under each of the plurality of multi-classification machine learning algorithms, while comparing overall precision, mean value, and weighted mean value of final prediction results for each damage mode by different algorithms in the plurality of multi-classification machine learning algorithms, and selecting an optimal multi-classification machine learning algorithm from the plurality of multi-classification machine learning algorithms to build the operating condition model according to a comparison result.

7. The method according to claim 6, wherein when building the mechanism model, the plurality of multi-classification machine learning algorithms include a logistic regression algorithm, a support vector machine (SVM) algorithm, and a random forest algorithm; and when building the operating condition model, the plurality of multi-classification machine learning algorithms include a K-nearest neighbors algorithm (KNN) algorithm, a random forest algorithm, and a Bernoulli algorithm.

8. A system for intelligent monitoring of equipment damage based on mechanism and operating condition big data, wherein the method according to claim 1 is applied, and the system comprises:
a sample building module, configured to set the plurality of damage modes of the pressure equipment, build the mechanism model samples for the each damage mode based on the technical standard and the engineering cases, and build the operating condition big data samples for the each damage mode based on the field data;
a model building module, configured to use the mechanism model samples and the operating condition big data samples as the dataset for model training, respectively to build the mechanism model and the operating condition model; and
a calculation module, configured to input the real-time text data to be predicted and the real-time operating condition data into the mechanism model and the operating condition model respectively, calculate the first possibility that the real-time text data belongs to each of the plurality of damage modes, and the second possibility that the real-time operating condition data belongs to the each of the plurality of damage modes, and generate the equipment damage monitoring result based on the first possibility and the second possibility.
